(19) United States
(12) Patent Application Publication
(10) Pub. No.: US 2008/0100533 A1
(43) Pub. Date: May 1, 2008

(54) Adaptive Emission Frame Projection Display and Method

(76) Inventors: Charles Chia-ming Chuang, Shanghai (CN); Joseph Marc McConnaughey, Shanghai (CN)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/926,139

(22) Filed: Oct. 29, 2007

Related U.S. Application Data
(60) Provisional application No. 60/863,576, filed on Oct. 31, 2006.

(51) Int. Cl. G09G 3/18

(52) U.S. Cl. 345/52

(57) ABSTRACT

A projection image display system includes a plurality of emission sources and a power controller capable of programmable emission frame cycles. The power controller can program each of the emission sources to enhance the display performance of incoming video.

### CROSS REFERENCE TO RELATED APPLICATIONS

This application claims priority to and incorporates by reference U.S. Patent Application No. 60/863,576 filed Oct. 31, 2006 entitled “Adaptive Emission Frame Projection Display and Method” by inventors Charles Chuang et al.

### FIELD OF THE INVENTION

The present invention relates to projection image display systems and, in particular, to emission sources such as Light Emitting Diodes (LEDs) and Lasers where emission frame cycles can be programmed and the video display performance optimized.

### BACKGROUND OF THE INVENTION

High resolution, large format displays using the projection technology have been well accepted in the market place. Display images may be formed by transmitting or reflecting light from a high-intensity light source through a spatial light modulator such as a digital micro-mirror device (DMD), liquid-crystal-on-silicon (LCOS) or liquid crystal display (LCD). There are two major architectures for projection optics. The first architecture uses multiple spatial light modulators in parallel and merging the video together using dichroic prisms. The advantage of this architecture is high luminance output, but the product cost is high because multiple spatial light modulators and associated circuits are needed. Merging and aligning multiple light paths together in production is a tedious process. For example, 3 spatial light modulators, one for Red light, one for Green light, and one for Blue light, must be aligned perfectly in order to produce a video pattern consisting of white lines or white text. Misalignment due to optical component production tolerance and optical component assembly can easily be picked up by human eyes.

The second architecture uses one spatial light modulator, and time multiplexes different color emission sources through the spatial light modulator at a high enough rate for the human visual system to not be able to differentiate the separate light patterns, thereby fusing the image. A typical implementation uses a color wheel with red, green, and blue filters in front of a white light source for color illumination sources. A video formatter is used to separate incoming video into red, green, and blue components and synchronize the spatial light modulator video pattern of a particular color with incoming color illumination sources. FIG. 3A shows a color wheel with red, green, blue patterns and a chart showing the emission frame of each color in time. This is a low cost architecture, since only one spatial light modulator is needed. However, time multiplexing reduces the luminous energy delivered to the spatial light modulator and the brightness of the projection system is lower than the first architecture with multiple spatial light modulators. A prior art variation on the single spatial light modulator architecture adds a transparent segment to the color wheel; this is shown in FIG. 3B, with corresponding chart for emission frames. The brightness is boosted with a corresponding reduction in the luminous intensity of the primary colors. A video formatter is used to separate incoming video into red, green, blue, and white components and synchronize the spatial light modulator pattern of a particular color with incoming color illumination sources. This is good for video with a lot of white content, but video with saturated color content will be dimmer, since the luminous intensity of primary colors are reduced. Conventional single spatial light modulator displays use emission sources with fixed emission frames, and cannot be optimized for the display of all types of video content.

As the light source ages, the color distribution changes. However, the projection display must maintain a correct mix of primary color luminous energy so the color on screen stay the same. For example, red LED luminance decays much faster over time when compared to green and blue LEDs. As the red LED brightness drops to 50% of the initial value, the green and blue LEDs could still be close to 100%. Conventional color management relies on optical detector to sense the amount of red LED brightness degradation and for the spatial light modulator to limit the maximum light output of green and blue to 50% in order to match the drop in red. So the overall light output drops to 50%. Another way to look at this is that 50% of the green and blue lights generated are not going to be used and the electric power used for its generation is wasted. FIG. 4A shows a standard color wheel with red, green, and blue taking ⅓ each of the color wheel, and the light output limitation imposed by the spatial light modulator as the red efficiency drops to one half. If the color emission frame is changed, as shown in FIG. 4B, so the red portion now takes 50%, and green and blue each takes 25%, the proper color balance is achieved and the spatial light modulator does not have to impose an upper limit on light transmission for the green and the blue. The result is an over all brightness loss of only 25% instead of 50%. So by changing the color emission frame, the brightness loss after the red LED lamp ages is improved. Conventional single spatial light modulator displays use fixed emission frame emission sources, and can be wasteful of energy in color compensation. Display performance degradation over time is also worse, since the emission frames cannot be changed.

Further, it is desirable to minimize energy consumption, especially for battery based projectors. The display performance should strive for an acceptable level instead of highest brightness or contrast. If for a period of time, a video content has 100% peak red, but at most 50% peak green and blue light content, a conventional single spatial light modulator display with fixed emission frame illumination source, would be wasteful of energy as shown in FIG. 4A where both green and blue light outputs are limited by the spatial light modulator. At that same period of time, by adapting to the video content, and extending the red emission frame as per FIG. 4B, the brightness level is higher by 50% over the prior art approach as shown in FIG. 4A. To conserve energy, the brightness level can be set to the same as the prior art approach as shown in FIG. 4A, and adapting to the video content by changing the emission frame structure, either by lower the driving current to the 66% level to LEDs as shown in FIG. 5A, or keep the driving level the same and turn off the LEDs for 33% of the time cycle as shown in FIG. 5B. By adapting emission frame structure to the characteristics of the incoming video in this example, 33% of energy is saved. If the emission frame is partitioned as in FIG. 4B, the brightness increase is very useful when user is in high ambient environment. It is highly desirable to be able to change the display characteristics based on user input. However, conventional single spatial light modulator displays use fixed emission frame illumination source, and cannot be controlled this way. When the emission frame is changed, the timing of each color video presented to the spatial modulator may change, and the video data may also have to be scaled by the video formatter.

### SUMMARY OF THE INVENTION

Embodiments of the invention provide a projection display with adaptive emission frames that can optimize video display for brightness/contrast, for color temperature change, for high ambient readability, for lamp aging compensation, or for energy consumption.

In another embodiment, an illumination system is capable of producing adaptive emission frames.

In an embodiment, an adaptive video processing method optimizes brightness/contrast or energy consumption.

In an embodiment of the invention, a system comprises a power controller and a plurality of light emitting modules coupled to the power controller. Each module emits a different color light and has a light source and light sensor. The power controller adjusts the duration during a cycle of light emission from each module based on the emitted light sensed by the sensors.

In an embodiment, a method comprises: emitting light from a plurality of light sources, each light source emitting a different color light; sensing the emitted light; and adjusting a duration of light emission during a cycle from each light source based on the sensing.

In an embodiment, a method comprises: emitting light from a plurality of light sources, each light source emitting a different color light; sensing the emitted light; and adjusting output current levels of each light emission during a cycle from each light source based on the sensing.

In an embodiment of the invention, a system comprises a smart video formatter that can adaptively change the emission frame structure based on the information from the signal conditioning block on the relative light output levels of the LEDs or laser modules; that can adaptively change the emission frame structure based on user changing the display mode for power savings, high ambient, or different color temperature applications; that can adaptively change the emission frame structure based on the characteristics of the incoming video stream.

In an embodiment, a method comprises: a smart video formatter that can adaptively change the emission frame structure based on the information from the signal conditioning block on the relative light output levels of the LEDs or laser modules; that can adaptively change the emission frame structure based on user changing the display mode for power savings, high ambient, or different color temperature applications; that can adaptively change the emission frame structure based on the characteristics of the incoming video stream.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a conventional rear projection display;

FIG. 2 is a block diagram illustrating a preferred embodiment of a rear projection display

FIG. 3A illustrates a conventional color wheel arrangement with red, green, blue (RGB) patterns and a chart showing the emission frame of each color in time;

FIG. 3B illustrates a conventional color wheel arrangement with red, green, blue, and white patterns and a chart showing the emission frame of each color in time;

FIG. 4A illustrates a conventional RGB color wheel arrangement and a chart showing the emission frame of each color in time, and the energy lost when red LED is aged and the color temperature is preserved;

FIG. 4B illustrates a color wheel arrangement where the red section is increased to 50%, and the green and blue sections are reduced to 25% each;

FIGS. 5A and 5B illustrates two ways of energy savings if the color emission frame could be changed from RGB 33%/33%/33% to RGB 50%/25%/25% and the light output is maintained at the 50% level;

FIG. 5C illustrates an embodiment with adaptive emission frames where the video content is used to turn on the red LEDs, then turn on the green LEDs (that produces yellow), then turn on the blue LEDs (that makes white);

FIG. 6 is an electrical block diagram illustrating a conventional illumination control system;

FIGS. 7A and 7B are electrical block diagrams illustrating two embodiments of an illumination control system; and

FIG. 8 is a flowchart illustrating a prior art method of maintaining color balance when emission source ages;

FIG. 9 is an embodiment of maintaining color balance when emission source ages;

FIG. 10 is a flowchart illustrating a conventional data buffering and data formatting function performed by the video formatter; and

FIG. 11 is a flowchart illustrating an embodiment of data buffering and data formatting function performed by the smart video formatter.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

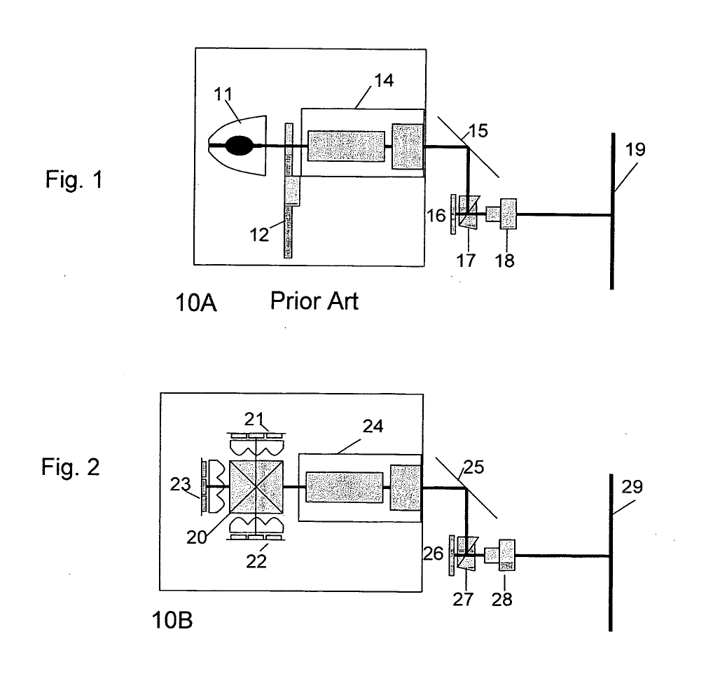

FIG. 1 is a block diagram illustrating a conventional rear projection display 10A. A short are lamp with a parabolic or hyperbolic mirror 11 is typically used as the source of broad spectrum white light source for the projection system 10A. A color wheel 12, is place in front of a white light beam emitted from the lamp/mirror 11. The color wheel 12 typically has red, green, and blue segments on it. As the color wheel rotates, filtered red, green, and blue lights are passed to a light pipe/relay lens pair 14. The light pipe 14 serves to homogenize the light beam and the relay lens 14 shapes the light beam to focus on a spatial light modulator 16. A mirror 15 and a prism 17 steer the light beam into the spatial light modulator 16. A typical spatial light modulator 16 is TI's diamond mirror device (DMD). The DMD has thousands of small mirrors on it, each one representing a pixel on the video projection screen. For pixels that are in the “on” state, the mirrors will steer the light toward a projection lens 18, then eventually toward the rear of a projection screen 19. Typically, there are one or two reflecting mirrors in between the projection lens and the screen in order to shorten the cabinet depth of the rear projection device. They are omitted for clarity.

FIG. 2 is a block diagram illustrating a preferred embodiment of a rear projection display 10B. An array of red light emitted diodes (LED) with a fly-eye lens 21 is used as the source of red light for the projection system 10B. Similarly an array of green LEDs with lens 23 is used as the source for green light, and an array of blue LEDs with lens 22 is used as the source for blue light. A dichroic prism 20 is used to merge all three color light sources and focus them onto the input port of a light pipe/relay lens pair 24. The light pipe 24 serves to homogenize the light beam and the relay lens 24 shapes the light beam to focus on a spatial light modulator 26. A mirror 25 and a prism 27 steers the light beam into the spatial light modulator 26. In an embodiment, the spatial light modulator 26 includes TI's diamond mirror device (DMD). The DMD has thousands of small mirrors on it, each one representing a pixel on the video projection screen. For pixels that are in the “on” state, the mirrors will steer the light toward a projection lens 28 then eventually toward the rear of a projection screen 29. Typically there are one or two reflecting mirrors in between the projection lens and the screen in order to shorten the cabinet depth of the rear projection device. They are omitted for clarity here. There are other physical configurations of the LEDs without the use of a dichroic prism, but the adaptive emission frame control mechanism described below is the same.

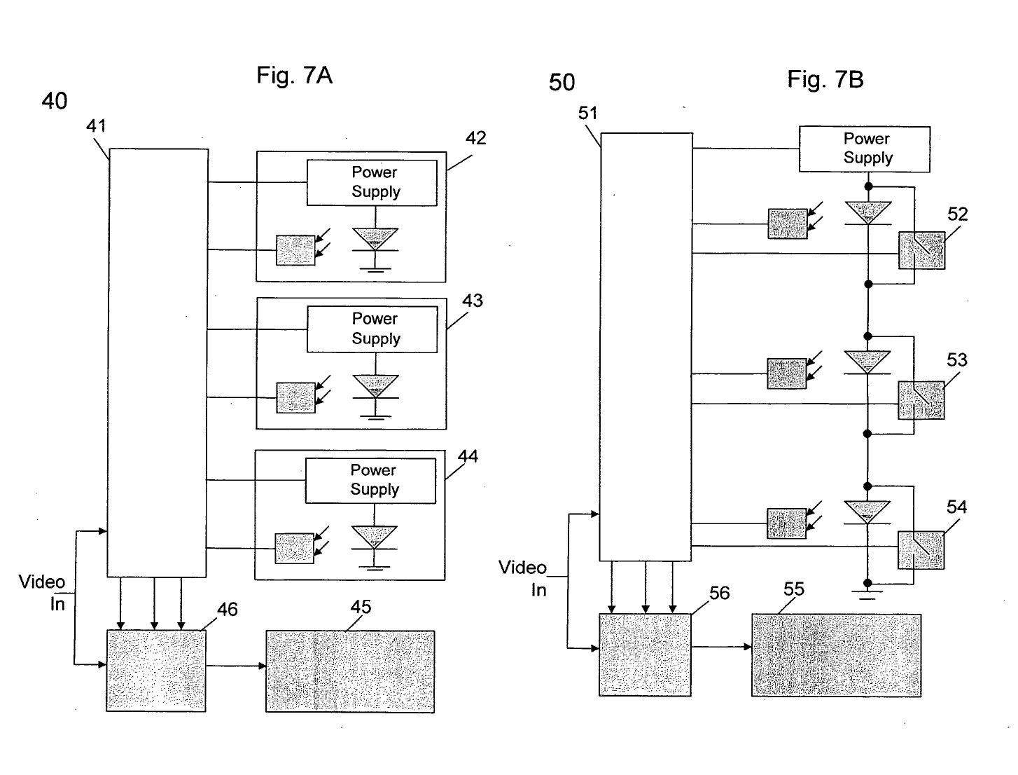

In order to control the emission frames of the arrays 21, 22, and 23, an illumination control system 40 or 50 is communicatively coupled to the arrays 21, 22, and 23. The system 40 and 50, which will be discussed in further detail in conjunction with FIG. 7A and FIG. 7B below, measure the output of each array and adjust the emissive frame accordingly to ensure that the emission levels of the 3 LEDs are kept at the same ratio in order to preserve color rendering of the images.

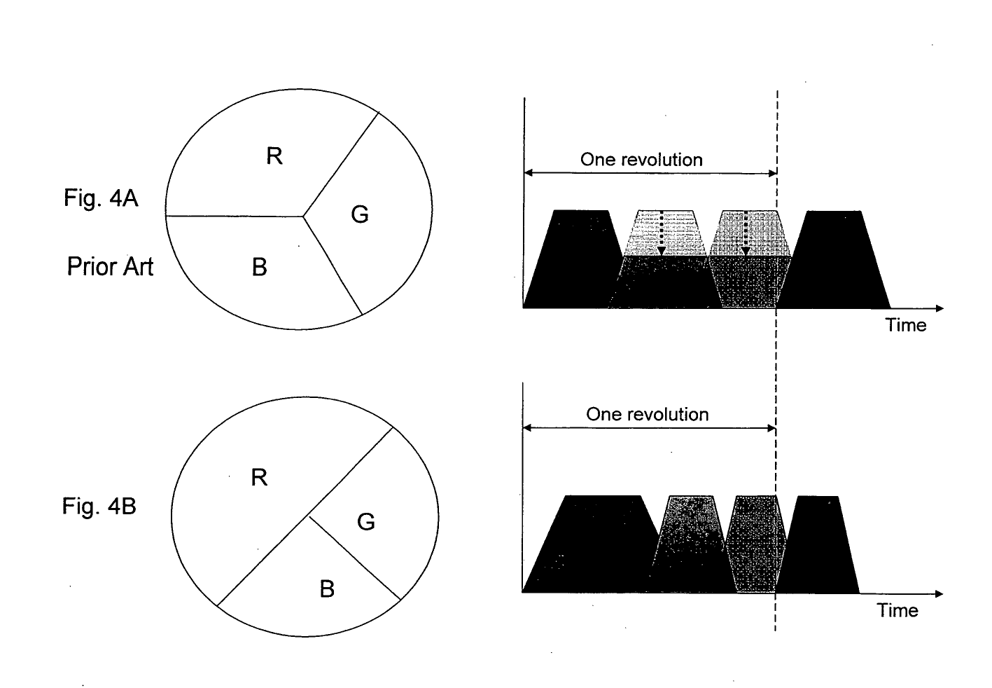

FIG. 4A illustrates a conventional RGB color wheel arrangement and a chart showing the emission frame of each color in time. It also shows that with the red light source aging and the emission being cut to 50%, the conventional spatial light modulator controller has to compensate by reducing the maximum Green and Blue light transmitted to a 50% level. The overall light level reduction is 50%. FIG. 4B illustrates a color wheel arrangement where the red section is increased to 50%, and the green and blue sections are reduced to 25% each. As the red light source ages and the emission is cut to 50%, the 4B emission time frame arrangement is now optimal. The overall light level reduction is only 25%. The 4B arrangement is 33% brighter than the 4A arrangement. In one embodiment, using a plurality of LEDs, laser diodes, organic LEDs, lasers, and/or other light sources where each light source can be controlled independently, and the color wheel is no longer used, the emission frame of each light source can be changed and an improved overall light degradation over time can be achieved. In an embodiment, a microcontroller can calculate and extend the emission duration of the red LED and to reduce the emission duration of the green and blue LEDs in order to optimize the energy efficiency.

We show an LED aging compensation computation in the following example. Let us define that the original brightness of the red, green, and blue LED are Ro, Go and Bo, and that they have aged and the current brightness are Rc, Gc, and Bc. Let us also define the original time slice in the emission frame for the red, green and blue LED are Tr, Tg, and Tb where Tr+Tg+Tb=a constant, where the emission frame is equal to, or emission frame is an integer multiple of this constant.

If the ratio of Ro*Tr to Go*Tg and Bo*Tb can be kept the same as LED aged, then the full range of all 3 LEDs can be utilized. So for red LED whose lifetime is shorter than the other two colors, emission frame can be modified to achieve this goal. The emission frame is modified by lengthening the emission time of red LEDs and decrease the emission time of both green and blue LEDs.

Time slice of the red LED can be increased by X1 and the time slices of the green LED can be decreased by X2, and blue LEDs can be decreased by (X1−X2) to satisfy the following condition:

(Ro*Tr)/[Rc*(Tr+X1)]=(Go*Tg)/[Gc*(Tg−X2)]

(Ro*Tr)/[Rc*(Tr+X1)]=(Bo*Tb)/[Bc*(Tb−(X1−X2)]

Above equations can be solved easily for X1 and X2 and the detail calculations are omitted here.

Conventional single spatial light modulator displays all uses fixed emission frame emission sources, and can be wasteful of energy in color compensation. Display performance degradation over time is also worse, since the emission frames cannot be changed. With a fixed lamp sources and fixed emission frames, the optical color temperature is also fixed. For a display with optimized color temperature at 9300 K, the conventional method of changing the color temperature to 6500 K is to reduce the green and blue output by the spatial light modulator, but the subsequent light output is reduced. With adaptive emission frame approach, the relative percentage of red, green, and blue emission frame can be changed for color temperature change, so the spatial light modulator does not have to scale down the light output; therefore, the brightness change over color temperature change is less.

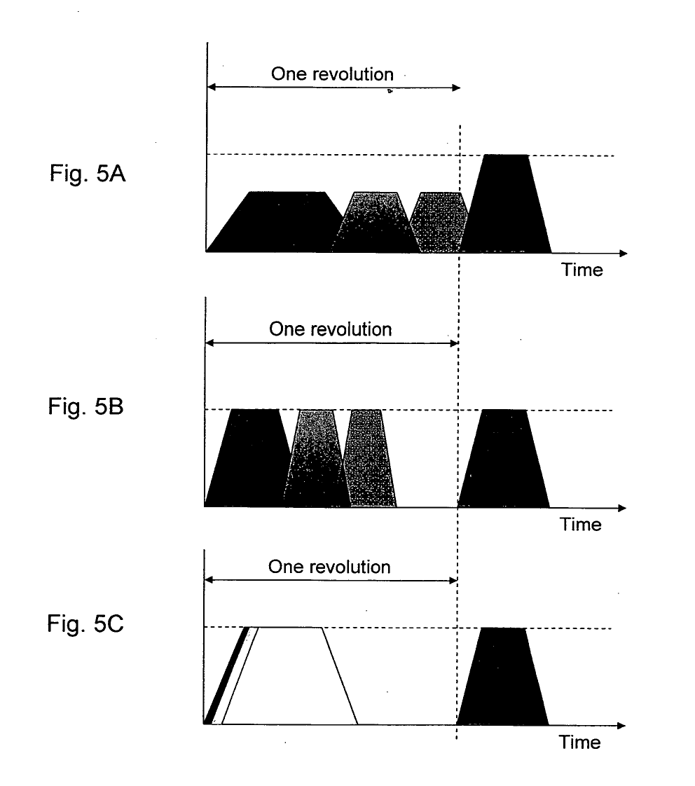

FIGS. 5A and 5B illustrates two preferred embodiment of energy savings if the color emission frame could be changed from RGB 33%/33%/33% to RGB 50%/25%/25% and the light output is maintained at the 50% level. FIG. 5A illustrates that the red, green, and the blue LEDs can be driven to 66% of the full level, thus realizing 33% energy savings. FIG. 5B shows that the red, green, and the blue LEDs are driven to the 100% of the full level, but the on time can be reduced to 66%, thus realizing 33% energy savings. In an embodiment, a microcontroller can calculate and extend the emission duration of the red LED and to reduce the emission duration of the green and blue LEDs in order to optimize the energy efficiency, and then to either reduce the driving current of all the LEDs or to reduce all the LEDs on duty cycle in order to meet the energy savings requirement given by the user.

FIG. 5C illustrates another embodiment with adaptive emission frames where the video content is constantly analyzed and the emission frames constantly changed to optimize video performance. For a duration of time, if the video content consist of some red, some yellow, and mostly white content, there is no reason to follow the conventional emission frame structure where one color is turned on one at a time. The emission structure can be changed to turn on the red LEDs, then turn on the green LEDs (that produces yellow), then turn on the blue LEDs (that makes white). As a matter of fact, an emission frame may consist of many permutations of red, green, blue, red+green, red+blue, and green+blue, and red+green+blue segments depending on the video content. The number of segments within an emission frame can change as video content changes. The time duration of each segment within an emission frame can change as video content changes.

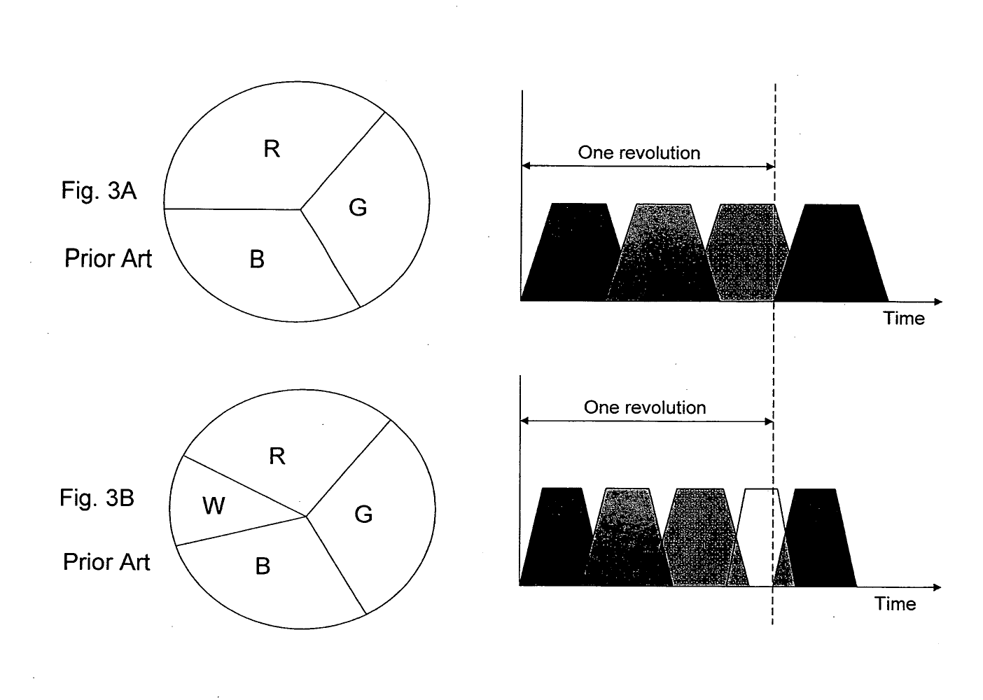

Another example is for the display of old black and white movies. Red, green, and blue LEDs can be turned on at all times for this, and the available white light is typically more than twice of a conventional color wheel shown in FIG. 3A. The projection display according to an embodiment of the invention uses adaptive emission frame that can show a black and white movie at more than twice the brightness and contrast of prior art displays and enhances the sun light readability. A business application is for a portable display in high ambient condition to reformat the incoming video data into grey scale displays and take advantage of adaptive emission frame brightness increases. In general, emission frames adaptive to input video stream allows a higher brightness and contrast display that is preferred in the marketplace. Emission frames adaptive to input video stream is very energy efficient, it can keep pace with prior art fixed emission frame display's brightness and contrast, scale down the power supply current to the light sources, or turn off light sources for a fraction of the display frame.

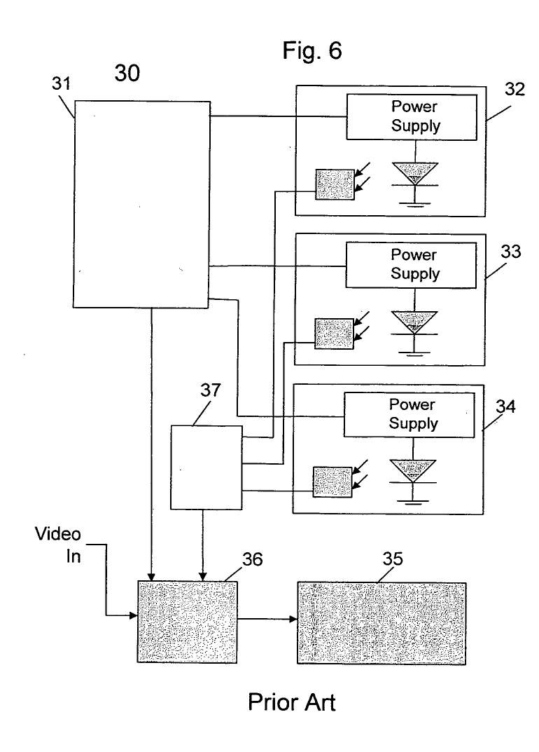

FIG. 6 is an electrical block diagram illustrating a conventional illumination control system 30. A programmable current source power supply is used to drive one LED, and a photo sensor can be used to sense the light output level of the LEDs. There are three of these blocks for three different color LEDs, red 32, green, 33, and blue 34. The sequencer or state machine 31 basically replaces the color wheel. It generates the control signals to the red, green, and blue power supplies in precise time sequence with no regard to the video input. A signal conditioning block 37 that takes the output of red, green, and blue light sensors and feeds the information to the video formatter block 36 for aging compensation. It is the video formatter block 36 that uses this information to limit the maximum lights that can pass through and keep the relative brightness levels of the 3 colors to a constant. Alternatively, the signal conditioning block 37 may feed the information to the sequencer or state machine 31 (connection not shown), where the current source levels are adjusted to keep the relative brightness levels of the 3 color light sources to a constant. The video formatter block 36 takes the incoming video and stores them on a frame buffer (not shown). It then reformats the video information into red only, green only, and blue only data blocks and sends them to the spatial light modulator 35 at the precise time period the emission frame of the correct color is on.

FIGS. 7A and 7B are electrical block diagrams illustrating two embodiments of an illumination control system 40 and 50, respectively. A smart power controller 41 that controls power supplies to the LEDs 21, 22 and 23 that produce the emission frame of each color in time as shown in FIG. 4B, 5A or 5B. A programmable current source power supply is used to drive one LED, and a photo sensitive device such as a photodiode, a CCD sensor, a CCD camera, or a CMOS camera, is used to sense the light output level of the LEDs. There are three of these blocks for three different color LEDs, red 42, green, 43, and blue 44. Alternatively, if the power supply output level can be reprogrammed at high speed, only one block is needed, with a relay device connecting one power supply to 3 LEDs. The smart controller 41 can sense the LED light output level changes and repartition the percentages of each light over time for compensation, as shown in FIG. 4B. The smart controller 41 can repartition the percentages of each light source over time for color temperature changes. The smart power controller 41 can sense the incoming video distribution and program the adaptive emission frame of each color LEDs to match it as shown in FIG. 5C. The smart power controller 41 is communicatively coupled to a smart video formatter block 46. The video reformatting is now adaptive to video inputs rather than fixed. In the example in FIG. 5C, the video content (a small portion of red, a small portion of yellow, and a large portion of white) is used to turn on the red LEDs, then turn on the green LEDs (that produces yellow), then turn on the blue LEDs (that makes white). The video reformatting is done by separating red only, yellow only, and then white only blocks instead of the original red, green, and blue. Different adaptive algorithms can be implemented on the smart power controller 41. In the maximum power saving mode, it can reproduce the brightness and contrast levels of a conventional circuit while saving power. In the maximum brightness contrast mode in high ambient lighting, it can output the maximum level allowed by the LED lamp sources. In order to adapt to scene changes in a movie, the smart power controller 41 may have several settings to switch to rather than adapt to each video frame. The controller 41 is coupled to a spatial light modulator 45, which is substantially similar to the modulator 35 and therefore will not be discussed in further detail herein.

FIG. 7B illustrates another embodiment where one power supply 57 is used to control all three LED sources 21, 22, and 23. Power transistors with very small series on resistance such as solid-state relays or IGFETs 52, 53, 54 are used to short against the Red LED 21, the green LED 23, and the Blue LED 22. Switch combinations controlled by the smart power controller 51 can produce all the color combinations with the restriction that the current level must be the same for all LEDs that are on at the same time.

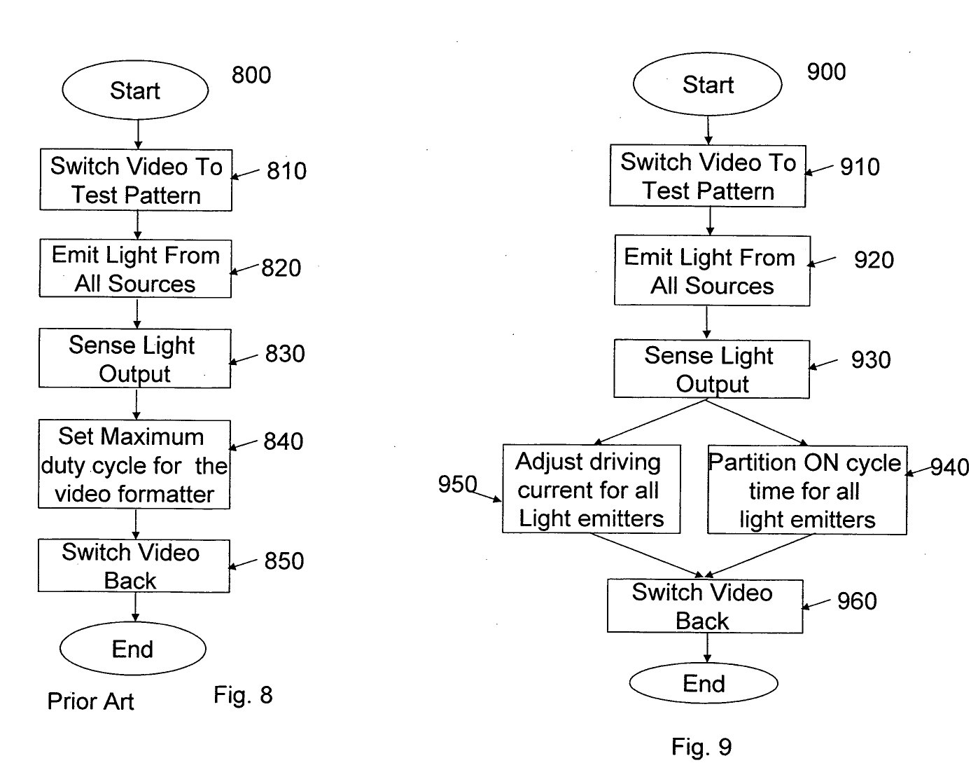

FIG. 8 is a flowchart illustrating a conventional method 800 of fixed emission frame color management. The video input is switched to a test pattern (810) of known color intensity. This can be a simple white or grey screen of a few frames. Light is emitted (820) from all sources either one at a time or in conjunction. The light output from each source is then sensed (830). The maximum duty cycle for the video formatter board for each color emitter is then fixed to preserve the correct color presentation of the video. The video source is then switched back to the original input source (850). When the projection display is first turned on the brightness of each emitter is different than when the display is warmed up. This color management method is used to ensure that the video color does not change as the projection display warms up. This color management method is also effective to compensate for emission source aging.

FIG. 9 is a flowchart illustrating a method 900 of generating adaptive emission frames. The video input is switched to a test pattern (910) of known color intensity. This can be a simple white or grey screen of a few frames. Light is emitted (920) from all sources either one at a time or in conjunction. The light output from each source is then sensed (930). The amount of emission time is then partitioned (940) based on the sensing (930) to compensate for degradation caused by aging or other factors. Driving current is then adjusted (950) and/or all the sources are turned (950) off for a time percentage. The method 900 then ends. In an embodiment of the invention, the method 900 can be performed in an order other than that described above. In addition, the partitioning (940), the adjusting (950); and turning (950) off can be omitted in an embodiment. In another embodiment of the invention, if the sensing is done prior to spatial light modulator, then test pattern step (910) and video switch back step (960) can be omitted.

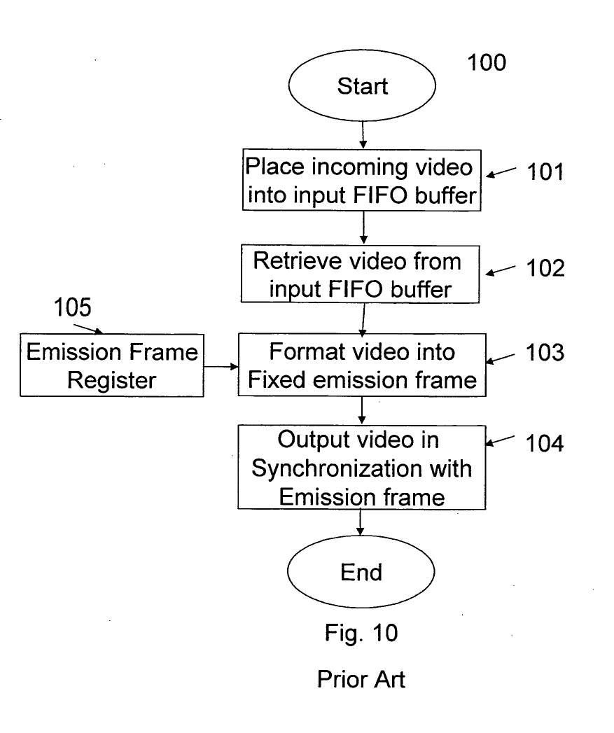

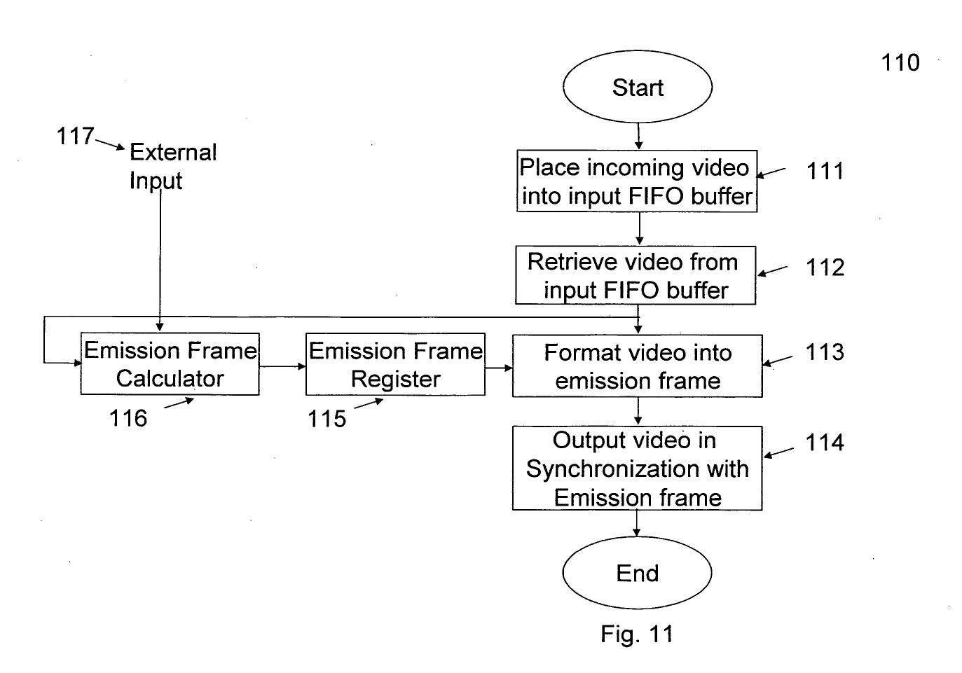

FIG. 10 is a flowchart illustrating a conventional method 100 of video processing through the video formatter. Incoming video is first stored in the input first-in first-out buffer or FIFO (101), typically more than one video frame is stored in this FIFO. As the video is retrieved from the FIFO (102), it is separated into several segments (103) according to the emission frame register (105). For example, if the emission frame is structured as shown in FIG. 3B with red, green, blue, and white segments, then the incoming video frame is separated into these four segments. Prior art emission frame is either fixed by design, or constructed once during the production of the set. Typical video input consists of red, green, and blue colors only. The white segment can be synthesized by picking equal amount of red, green, and blue out of each pixel and then subtract this “white” value from each of the three original colors. Once the video content is formatted for the correct segmentation, each segment is output to the light engine in synchronization with the fixed emission frame (104).

FIG. 11 is a flowchart illustrating an embodiment of a method 110 of video processing through the video formatter. Incoming video is first stored in the input first-in first-out buffer or FIFO (111), typically more than one video frame is stored in this FIFO. As the video is retrieved from the FIFO (112), it is separated into several segments (113) according to the emission frame register (115). The emission frame register (115) is adaptive to either external user input, or adaptive to incoming video via an emission frame calculator (116). The emission frame calculator can change the amplitude and the duration of the emission frame based on external input for color temperature change, or to go into power conservation mode. The emission frame calculator can change the amplitude and the duration of the emission frame by compiling a histogram of the incoming video and construct an emission frame to optimize for energy conservation or for maximum brightness.

Having illustrated and described the principles of the present invention in various embodiments, it should be apparent to those skilled in the art that the embodiment can be modified in arrangement and detail without departing from such principles. For example, the embodiments have been described with reference to DMD projectors. However, the adaptive emission device is equally suitable for image displays with transmissive image sources, with LCOS, and/or with LCDs. The adaptive emission frame was described using LED as the lamp source. However, other lamp sources such as laser diode, laser, OLED and incandescent lamps are also equally suitable.

What is claimed is:

1. A projection display system, comprising:
a programmable power controller; and
a plurality of light emitting modules coupled to the power controller, each module emitting a different color and having a light source and a light sensor;
wherein the power controller adjust the emission of the modules, based on the sensing, within an emission frame that enables a spatial light modulator to render video images.

2. The system of claim 1, wherein each module has a power supply and wherein the power controller adjusts the emitted light intensity by controlling the power supplies' turn on duty cycle or voltage/current levels.

3. The system of claim 1, further comprising a power supply coupled to each light source and wherein each module has a power transistor to short against the light sources.

4. The system of claim 1, further comprising a video formatter communicatively coupled to the power controller and to video input, the video formatter separating video input into color components of the emissive sources or additive components of multiple emissive sources and feeding the separated video input in a modulator.

5. The system of claim 4, wherein the video formatter separates video input into red, yellow and white components.

6. The system of claim 1, wherein the duty cycle of a module with diminished light output is lengthened with respect to other modules in order to keep the fractional output of all color light outputs in prescribed proportions.

7. The system of claim 1, wherein the power controller adjusts emission duration approximately inversely proportional to light intensity of each module sensed by each sensor.

8. The system of claim 1, wherein the power supply output level of a module with diminished light output is boosted with respect to other modules in order to keep the fractional output of all color light outputs in prescribed proportions.

9. A projection display system, comprising:
means for emitting light from a plurality of light sources, each light source emitting a different color light;
means for sensing the emitted light; and
means for adjusting the means for emitting based on data from the means for sensing.

10. A method, comprising:
emitting light from a plurality of light sources, each light source emitting a different color light;
sensing the emitted light; and
adjusting the emitting based on the sensing.

11. The method of claim 10, wherein each light source has an associated power supply and further comprising adjusting the emitted light intensity by controlling the power supplies' turn on duty cycle or voltage/current levels.

12. The method of claim 10, wherein each light source is coupled to a power supply and further comprising shorting a power transistor against the light sources.

13. The method of claim 10, further comprising
separating video input into color components of the emissive sources or additive components of multiple emissive sources; and
feeding the separated video input in a modulator.

14. The method of claim 13, wherein the separating video input separates video input into red, yellow and white components.

15. The method of claim 10, lengthening the duty cycle of a source with diminished light with respect to other modules in order to keep the fractional output of all color light outputs in prescribed proportions.

16. The method of claim 10, wherein the adjusting emission includes adjusting duration of emission approximately inversely proportional to light intensity of each source sensed.

17. The method of claim 10, wherein the adjusting includes boosting power supply output level of a source with diminished light output with respect to other sources in order to keep the fractional output of all color light outputs in prescribed proportions.

18. A method, comprising:
emitting light from a plurality of light sources, each light source emitting a different color light; and
adaptively changing the emitting based on a user selection.

19. The method of claim 18, wherein the user selection includes one of power savings;
high ambient; and color temperature applications.

20. The method of claim 18, wherein the user selection includes power savings and the changing includes extending emission duration of a red light source and reducing the emission duration of green and blue light sources.

21. An apparatus, comprising:
a video formatter; and
a plurality of light emitting modules coupled to the video formatter, each module emitting a different color and having a light source;
wherein the video formatter adjusts the emission of the modules, based on a user selection, within a fixed video frame that enables a spatial light modulator to render video images.

22. The apparatus of claim 21, wherein the user selection includes one of power savings; high ambient; and color temperature applications.

23. The apparatus of claim 21, wherein the user selection includes power savings and the video formatter changes the adjusts the emission by extending emission duration of a red light source and reducing the emission duration of green and blue light sources.

24. A method, comprising:
emitting light in an emission frame from a plurality of light sources, each light source emitting a different color light; and
changing the amplitude and the duration of the emission frame by compiling a histogram of incoming video and constructing an emission frame to optimize for energy conservation or for maximum brightness.

25. The method of claim 24, wherein the emission frame is optimized for energy conservation by extending emission duration of a red light source and reducing the emission duration of green and blue light sources.

26. The method of claim 24, wherein the duty cycle of each source is programmed to different settings for different color temperature applications

27. The method of claim 24, wherein the duty cycle of each source is adaptively programmed to the color or brightness profile of input video.

28. The method of claim 27, wherein the duty cycles of each source overlap or have multiple on/off cycles.

29. The method of claim 24, further comprising adaptively programming the power supply voltage/current level of each source to the color or brightness profile of input video.

30. An apparatus, comprising:
a video formatter; and
a plurality of light emitting modules coupled to the video formatter, each module emitting a different color in an emission frame and having a light source;
wherein the video formatter changes the amplitude and the duration of the emission frame by compiling a histogram of incoming video and constructing an emission frame to optimize for energy conservation or for maximum brightness.

31. The apparatus of claim 30, wherein video formatter optimizes the emission frame for energy conservation by extending emission duration of a red light source and reducing the emission duration of green and blue light sources.

32. The apparatus of claim 30, wherein the duty cycle of each module are programmed to different settings for different color temperature applications

33. The apparatus of claim 30, wherein the duty cycle of each module are adaptively programmed to the color or brightness profile of input video.

34. The apparatus of claim 33, wherein the duty cycles of each module overlap or have multiple on/off cycles.

35. The apparatus of claim 30, wherein the power supply voltage/current level of each module are adaptively programmed to the color or brightness profile of input video.
